(19) United States
(12) Patent Application Publication
(10) Pub. No.: US 2025/0298228 A1
(43) Pub. Date: Sep. 25, 2025

(54) Mid-Infrared Optical Lens Assemblies for Confocal Laser Scanning Microscopy

(71) Applicant: The Board of Trustees of the University of Illinois, Urbana, IL (US)

(72) Inventors: Kevin Lee Yeh, Urbana, IL (US); Rohit Bhargava, Urbana, IL (US)

(21) Appl. No.: 19/081,029

(22) Filed: Mar. 17, 2025

Related U.S. Application Data
(60) Provisional application No. 63/567,768, filed on Mar. 20, 2024.

(51) Int. Cl. G02B 21/00; G02B 13/14; G02B 13/18

(52) U.S. Cl. CPC G02B 21/0072; G02B 13/14; G02B 13/18; G02B 21/0032; G02B 21/0036

(57) ABSTRACT

The disclosure includes systems and methods for performing mid-infrared microscopy with refractive lenses. An example system includes a plurality of lenses for focusing mid-infrared light at a sample plane and collecting mid-infrared light at an image plane. The plurality of lenses includes a refractive scan lens, configured to focus the mid-infrared light at an intermediate image plane and configured to be adjusted by a beam steering device. The plurality of lenses also includes a refractive objective lens, configured to focus the mid-infrared light at the sample plane. The plurality of lenses also includes a refractive tube lens, configured to direct the mid-infrared light to the refractive objective lens and configured to focus the mid-infrared light at the intermediate image plane. At least two of the plurality of lenses are arranged along an optical axis.

### CROSS-REFERENCE TO RELATED APPLICATION

The present application claims the benefit of U.S. Patent Application No. 63/567,768, filed Mar. 20, 2024, the content of which is herewith incorporated by reference.

### STATEMENT REGARDING FEDERALLY SPONSORED RESEARCH OR DEVELOPMENT

This invention was made with government support under grant number R01EB009745, awarded by the National Institutes of Health (NIH). The government has certain rights in the invention.

### BACKGROUND

Chemical imaging, especially mid-infrared spectroscopic microscopy, can improve label-free biomedical analyses while achieving expansive molecular sensitivity. Current lens systems and methods for microscopy often rely on reflective lenses in the mid-infrared regime or refractive lenses outside of the mid-infrared regime, neither of which are able to perform high-quality image analysis rapidly and at high resolution in the mid-infrared regime. Accordingly, there exists a need for systems and methods of using refractive lenses for microscopy in the mid-infrared regime.

### SUMMARY

Embodiments of the present disclosure include systems and methods for using refractive lenses for microscopy in the mid-infrared regime. Specifically, these include systems and methods of using refractive lenses in the mid-infrared regime for laser-scanning microscopes (LSMs) and scanning microscopes, either of which may be widefield or confocal microscopes. In certain embodiments, the mid-infrared regime can include light of wavelengths between 2 micrometers and 12 micrometers. It will be understood that other infrared wavelengths are contemplated and possible within the scope of the present disclosure. In some embodiments, the refractive lenses may include lens elements that include an aspheric surface, and in some embodiments, the refractive lenses may be infinity-corrected. Certain embodiments include lens elements made of barium fluoride (BaF₂), zinc sulfide (ZnS), and/or zinc selenide (ZnSe). It will be understood that other infrared-transmitting materials are contemplated and possible. Some embodiments further include a light source configured to emit illumination light, and detectors configured to convert received light into an electrical signal. In some further embodiments, a digital image may be generated based on information received from a detector.

In a first aspect, a system for performing mid-infrared microscopy with refractive lenses is provided. The system includes a plurality of lenses for focusing emitted mid-infrared light at a sample plane and collecting received mid-infrared light at an image plane. The plurality of lenses are configured to refractively interact with the emitted mid-infrared light and the received mid-infrared light. The plurality of lenses includes a refractive scan lens, where the refractive scan lens is configured to focus the emitted mid-infrared light at an intermediate image plane and where the refractive scan lens is configured to be adjusted by a beam steering device. The plurality of lenses also includes a refractive objective lens, where the refractive objective lens is configured to focus the emitted mid-infrared light at the sample plane. The plurality of lenses also includes a refractive tube lens, where the refractive tube lens is configured to direct the emitted mid-infrared light to the refractive objective lens and where the refractive tube lens is configured to focus the received mid-infrared light at the intermediate image plane. At least two of the plurality of lenses are arranged along an optical axis.

In a second aspect, a system for performing mid-infrared microscopy with refractive lenses is provided. The system includes a plurality of lenses for focusing emitted mid-infrared light at a sample plane and collecting received mid-infrared light at an image plane. The plurality of lenses are configured to refractively interact with the emitted mid-infrared light and the received mid-infrared light. The plurality of lenses includes a refractive scan lens, where the refractive scan lens is configured to focus the emitted mid-infrared light across the sample plane and where the refractive scan lens is configured to be adjusted by a beam steering device. The plurality of lenses are arranged along an optical axis.

In a third aspect, a method of performing mid-infrared microscopy with refractive lenses is provided. The method includes causing a light source to emit mid-infrared light via a refractive scan lens so as to illuminate a portion of a sample plane. The refractive scan lens is configured to focus the emitted mid-infrared light across the sample plane. The method also includes receiving, via a detector, information indicative of the illuminated portion of the sample plane. The method further includes generating, based on the received information, a digital image of the sample plane.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 illustrates a system for a confocal laser-scanning microscope, according to an example embodiment.

FIG. 2A illustrates a scan lens, a tube lens, and an objective lens, according to example embodiments.

FIG. 2B illustrates a scan lens, a tube lens, and objective lenses, according to example embodiments.

FIG. 3A illustrates a scan lens, according to an example embodiment.

FIG. 3B illustrates a scan lens element, according to an example embodiment.

FIG. 3C illustrates a scan lens element, according to an example embodiment.

FIG. 4A illustrates a tub lens, according to an example embodiment.

FIG. 4B illustrates a tube lens element, according to an example embodiment.

FIG. 4C illustrates a tube lens element, according to an example embodiment.

FIG. 5A illustrates an objective lens, according to an example embodiment.

FIG. 5B illustrates an objective lens element, according to an example embodiment.

FIG. 5C illustrates an objective lens element, according to an example embodiment.

FIG. 5D illustrates an objective lens element, according to an example embodiment.

FIG. 6A illustrates an objective lens, according to an example embodiment.

FIG. 6B illustrates an objective lens element, according to an example embodiment.

FIG. 6C illustrates an objective lens element, according to an example embodiment.

FIG. 6D illustrates an objective lens element, according to an example embodiment.

FIG. 6E illustrates an objective lens element, according to an example embodiment.

FIG. 7 is a flow chart for a method of using refractive lenses for microscopy in the mid-infrared regime, according to example embodiments.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. OVERVIEW

Infrared spectroscopic imaging provides molecular sensitivity through resonant light absorption at mid-infrared frequencies. Infrared spectroscopic imaging systems that utilize refractive lenses are desirable, as refractive lenses have the potential to improve spectral data quality and imaging speed. Accordingly, systems and methods for performing mid-infrared microscopy with refractive lenses are disclosed within. Example systems utilize a light source that emits mid-infrared light and a series of infrared refractive lenses to illuminate and study objects.

Specifically, infrared spectroscopic imaging as described herein involves emitting the mid-infrared light through a refractive scan lens to scan across the sample plane to image the object being observed. In some embodiments, the light source used is an external cavity quantum cascade laser (QCL) array, known for its narrow-band beam, which is tunable across the molecular fingerprint spectral range. This allows for high intensity, signal strength, and spatial localization, contributing to the overall efficiency and speed of the imaging process.

Information about the illuminated part of the object can be collected by a detector, and a digital image of the object can be generated based on this information. This approach allows for label-free chemical imaging, providing both molecular and morphological contrast intrinsically from the sample itself.

The systems and methods disclosed herein can include several refractive lenses, with specific materials and optical properties. These lenses work together to gather mid-infrared light from the object and form an image of it. In some embodiments, a refractive scan lens, a refractive tube lens, and a refractive objective lens are configured to refractively interact with the mid-infrared light. In some cases, the refractive scan lens may be adjusted by a beam steering device to focus mid-infrared light across an intermediate image plane that is magnified and conjugate to a sample plane. The refractive tube lens may direct mid-infrared light to the refractive objective lens. The refractive objective lens may focus the mid-infrared light at the sample plane, and may pair with a tube lens such that together, two conjugate image planes are created. At the focal plane of the tube lens (the intermediate image plane), a magnified image of the sample may be created.

In some cases, the system is designed to work with mid-infrared light wavelengths between 2 micrometers and 12 micrometers. It will be understood that other wavelengths of infrared light are possible and contemplated within the scope of the present disclosure. For example, long-wave infrared (e.g., 15 micrometers) are within the scope of the present disclosure as well. Additionally, although certain lens assemblies are described herein, it will be understood that other lens assemblies and systems are possible and contemplated within the scope of the present disclosure. For example, other embodiments may include hybrid systems, which may contain a combination of refractive surfaces, diffractive surfaces, reflective surfaces, and/or metasurfaces.

The number of lenses and the designs of their respective lens elements, as well as the materials used in each of the lens elements can be chosen based on desired optical properties, such as a desired numerical aperture. Additionally, the lens elements may include one or more aspheric surfaces to help correct aberrations and reduce the number of components in the system. In some cases, the refractive scan lens is designed with two elements, one made of barium fluoride (BaF₂) and the other of zinc sulfide (ZnS). The tube lens may be designed with two elements, one of barium fluoride (BaF₂) and the other of zinc sulfide (ZnS). The objective lens could have three or four elements, among other possibilities and be made of a combination of zinc selenide (ZnSe), barium fluoride (BaF₂), and zinc sulfide (ZnS). It will be understood that other materials or combinations of materials are possible and contemplated.

Overall, these systems and methods provide a more accurate and efficient approach to label-free chemical imaging in the mid-infrared range, with potential applications in scientific and biomedical fields.

### II. EXAMPLE SYSTEMS

### Example Microscope Systems

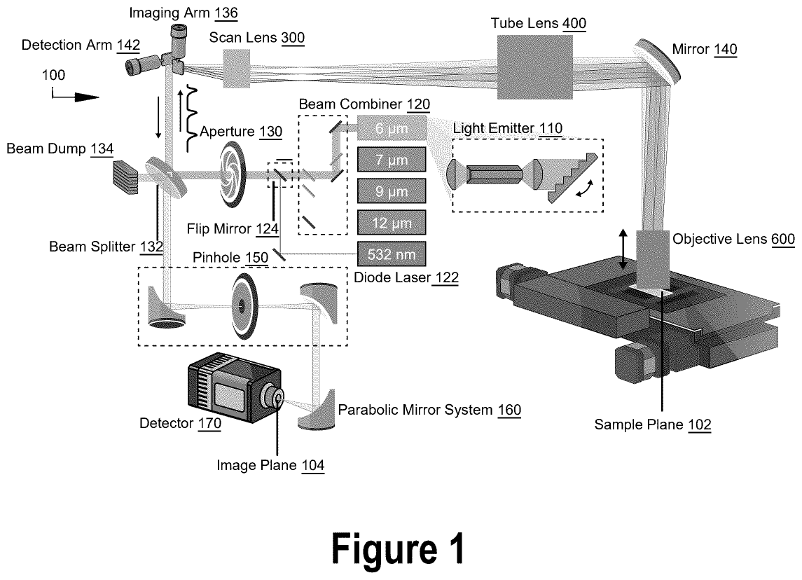

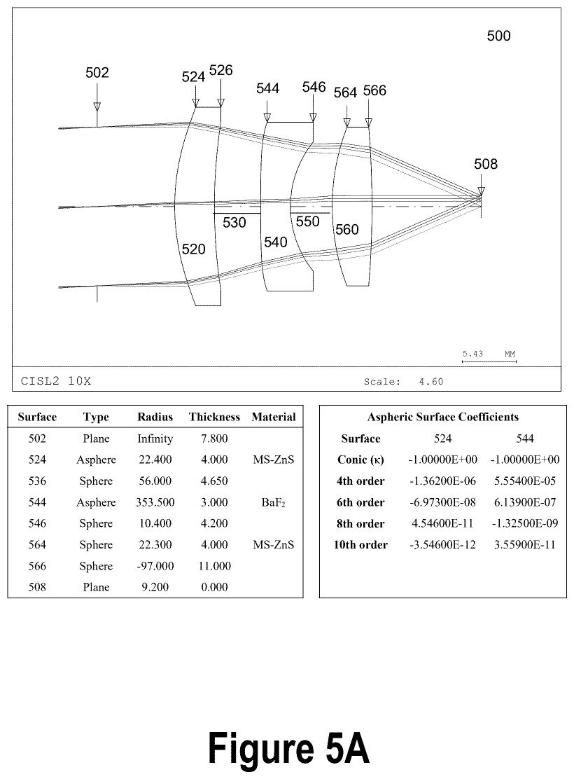

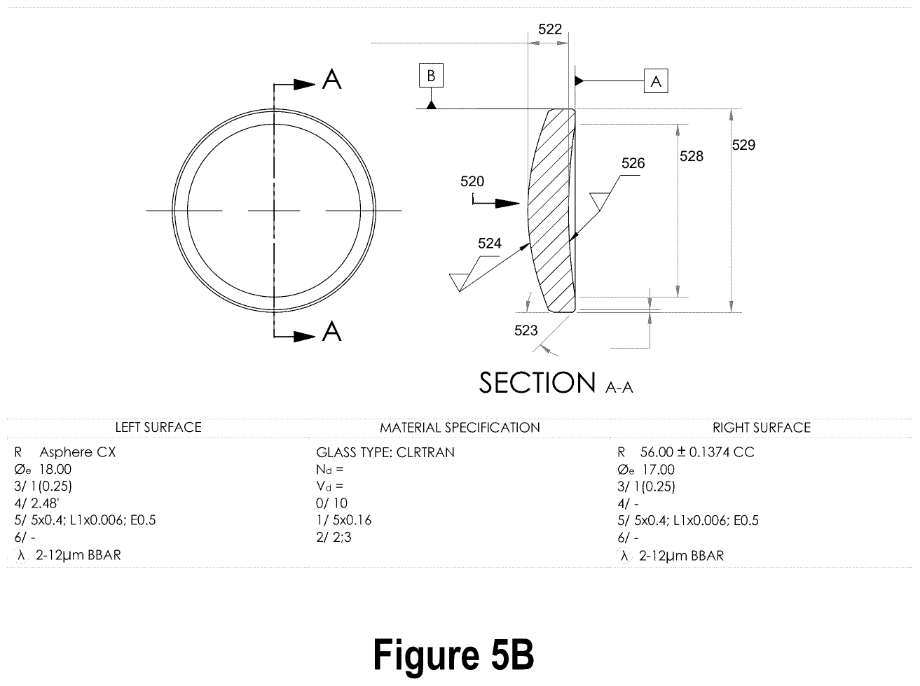

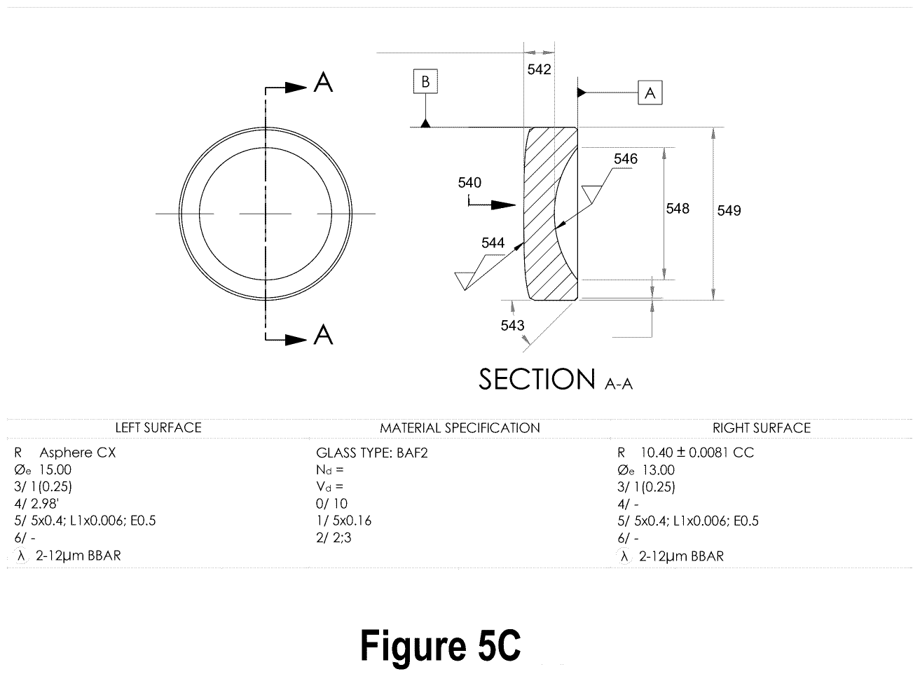

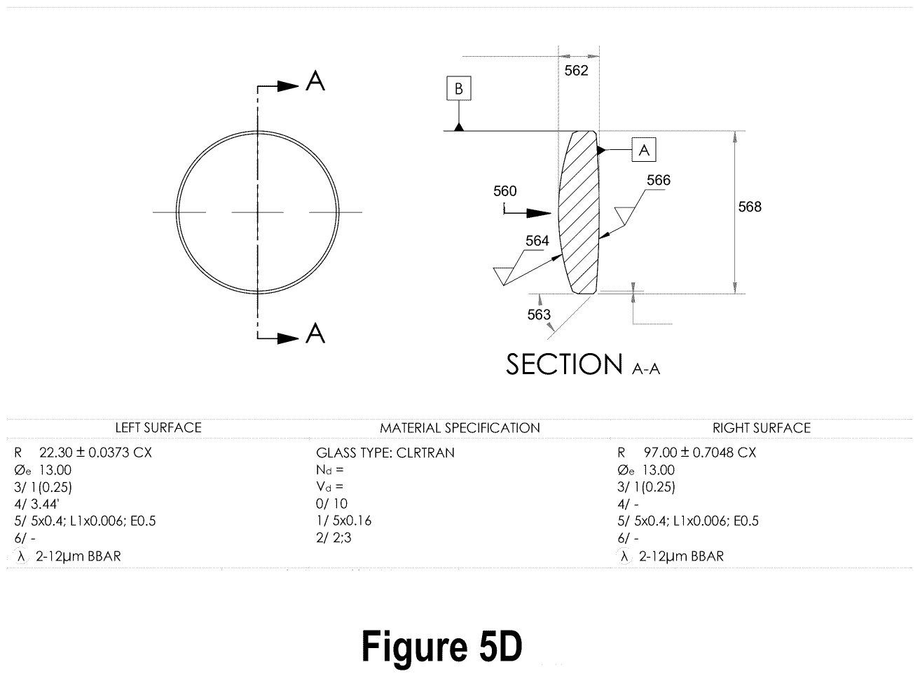

FIG. 1 illustrates an overview of microscope 100 for performing mid-infrared microscopy with refractive lenses. Specifically, FIG. 1 illustrates a laser scanning confocal microscope (LSM), using scan lens 300, tube lens 400, and objective lens 600. In some embodiments, such as a scanning microscope, microscope 100 may include a scan lens 300 without tube lens 400. Other configurations of microscope 100 with various combinations of scan lens 300, tube lens 400, and objective lens 600, or other lenses not shown in FIG. 1 are possible and within the scope of this disclosure. As an example, objective lens 500 of FIGS. 5A-5E could be used instead of objective lens 600. Additionally, while FIG. 1 illustrates a confocal microscope, widefield or other microscope designs and/or configurations are possible and within the scope of this disclosure. For example, additional or alternative embodiments may include bright field microscopy, dark field microscopy, fluoresce microscopy, holography, and/or structured illumination microscopy.

Microscope 100 can include light emitter 110, which may be configured to emit light along an optical axis, for example towards sample plane 102. In some embodiments, the optical axis may be folded. Light emitter 110 may be configured to emit light in the infrared or mid-infrared range, for instance wavelengths from 2 micrometers to 5 micrometers. Light emitter 110 may be a laser, for example a quantum cascade laser (QCL), such as an external cavity (EC) QCL array, an interband cascade laser (ICL), an optical parametric oscillator (OPO), and/or a thermal source. Additionally, it will be understood that any light source that can be configured to emit light in the 2 micrometer to 12 micrometer wavelength range may be used. For instance, light emitter 110 as shown in FIG. 1 may be a LaserTune EC QCL. In a case where light emitter 110 is an EC QCL, light emitter 110 may contain 4 separate tuners with various specifications (e.g., 6 micrometers, 7 micrometers, 9 micrometers, and 12 micrometers) and span a wavenumber range of about 5.3 micrometers to 12.8 micrometers, as indicated in FIG. 1. Light emitter 110 may be configured to be tunable to a specific band of interest by rotating a grating. The intensity of light emitter 110 may be configured to be modulated, for instance with a duty cycle of 4% and pulse repetition frequency of 1 MHz.

Microscope 100 can include beam combiner 120, which may be positioned along an optical axis such that light emitted from light emitter 110 passes through beam combiner 120. Beam combiner 120 may be configured to improve collinearity and direct the emitted light through an aperture 130. In some examples, beam combiner 120 may further include diode laser 122 for guidance, for example a 532 nm diode laser. Diode laser 122 may be configured to emit light toward a flip mirror 124 to direct the light emitted from diode laser 122 and light emitter 110.

Microscope 100 can include beam splitter 132, through which aperture 130 may direct light. In some examples, beam splitter 132 may be a primary beam splitter, for instance a KBr infrared beam splitter. Additionally, microscope 100 can include beam dump 134 to block residual light. The emitted light may directed be towards imaging arm 136 of microscope 100.

Microscope 100 can include imaging arm 136. Imaging arm 136 may be configured steer the light via an XY galvanometer (galvo) optical laser scanner, for instance 6215H from Cambridge Technology, with a fast axis controlled by a symmetric modified triangular waveform for bidirectional raster scanning. These operations may help avoid fly-back time and, in some examples, achieve a scan duty cycle of 90%. Scans by imaging arm 136 in the forward and reverse directions may be aligned by tracking the real-time position output and further adjusting the data stream by the system response time. Other configurations may additionally or alternatively include other beam steering mechanisms, for instance XYZ galvo scanning systems, resonant scanners, rotating prisms, and/or MEMs devices. Additionally, while imaging arm 136 may be configured to steer the light, other embodiments may use different beam steering devices, for example to adjust scan lens 300.

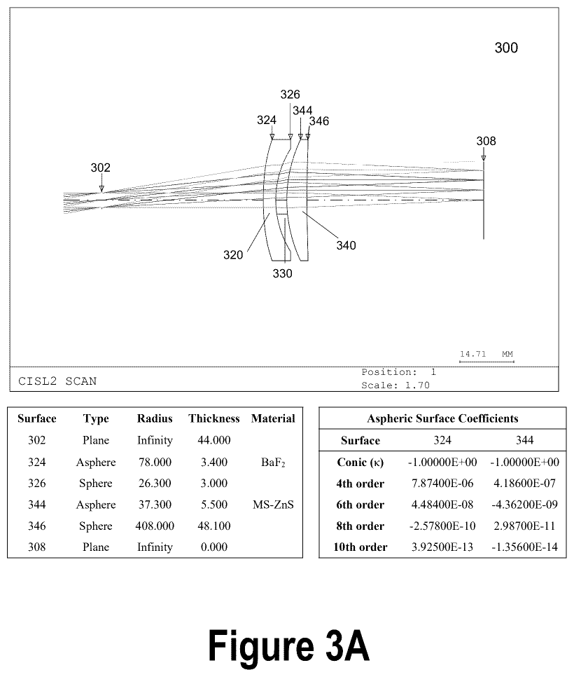

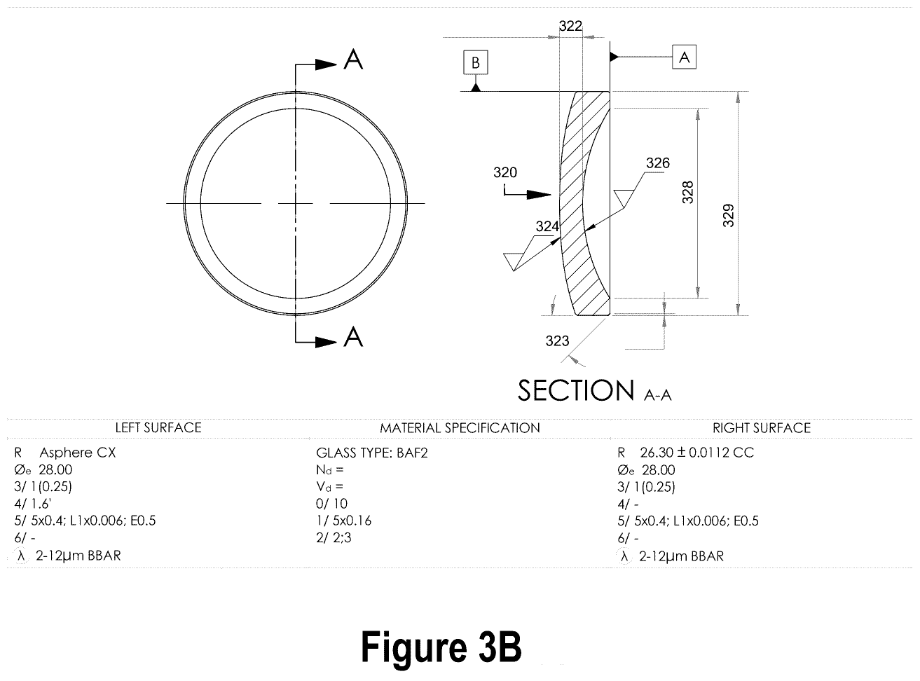

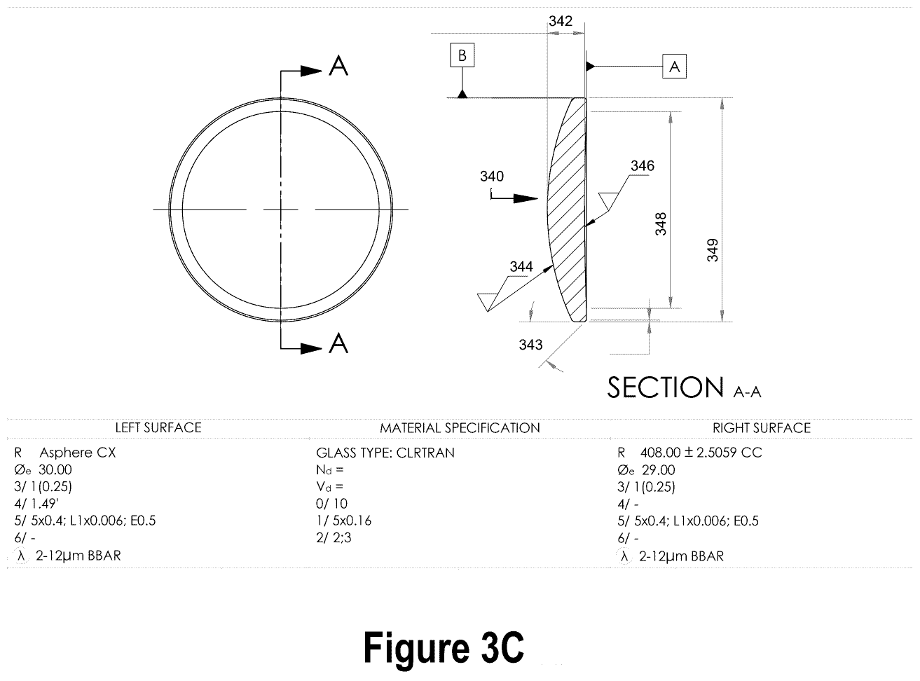

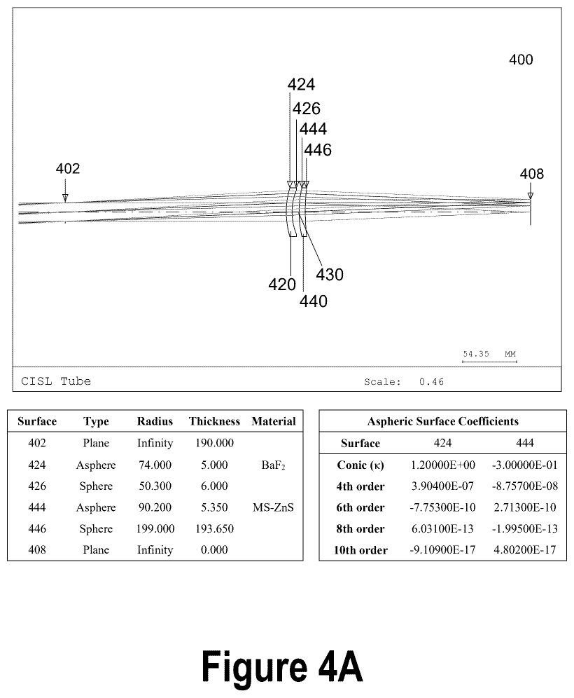

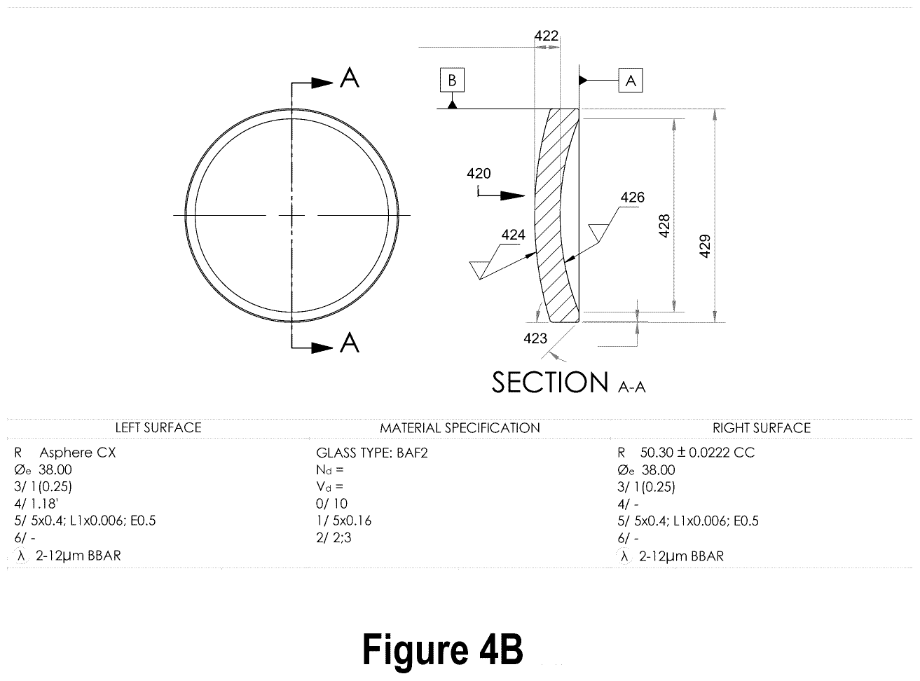

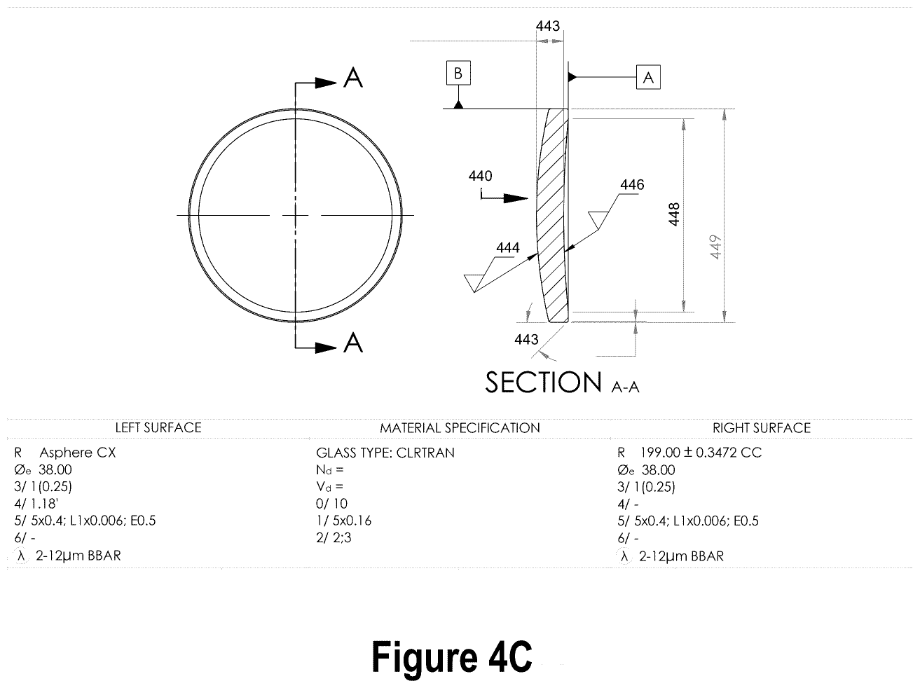

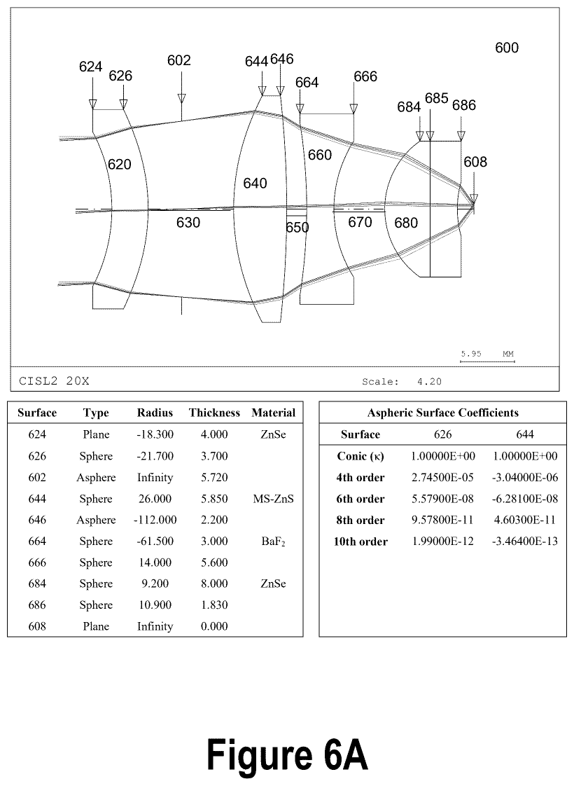

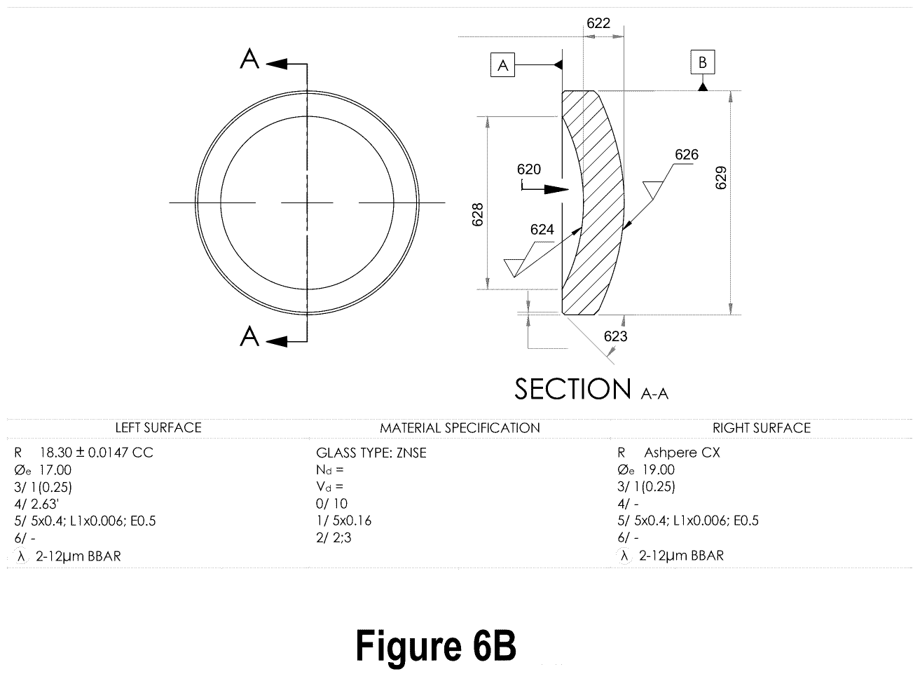

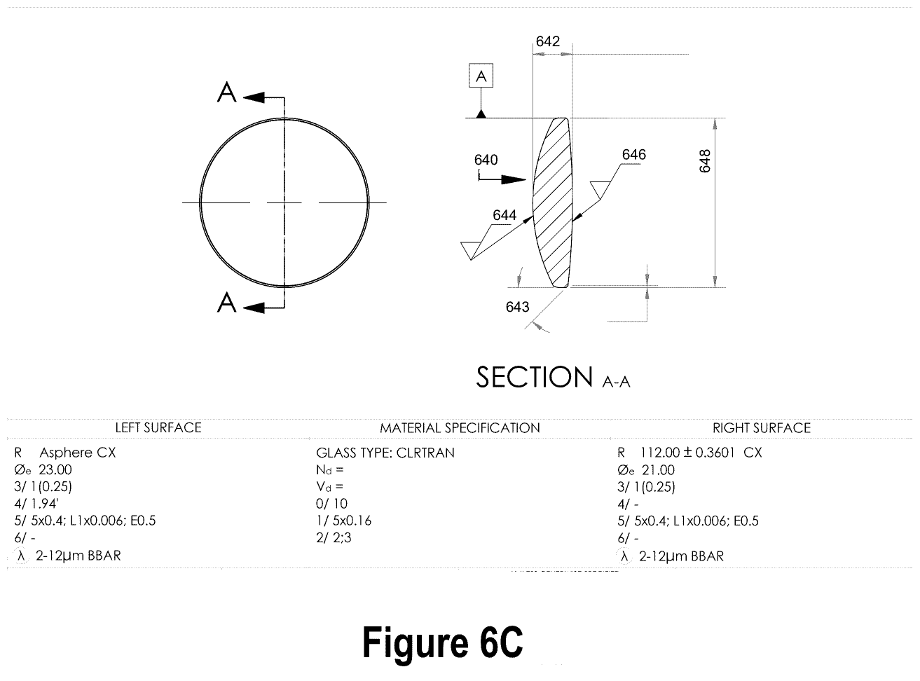

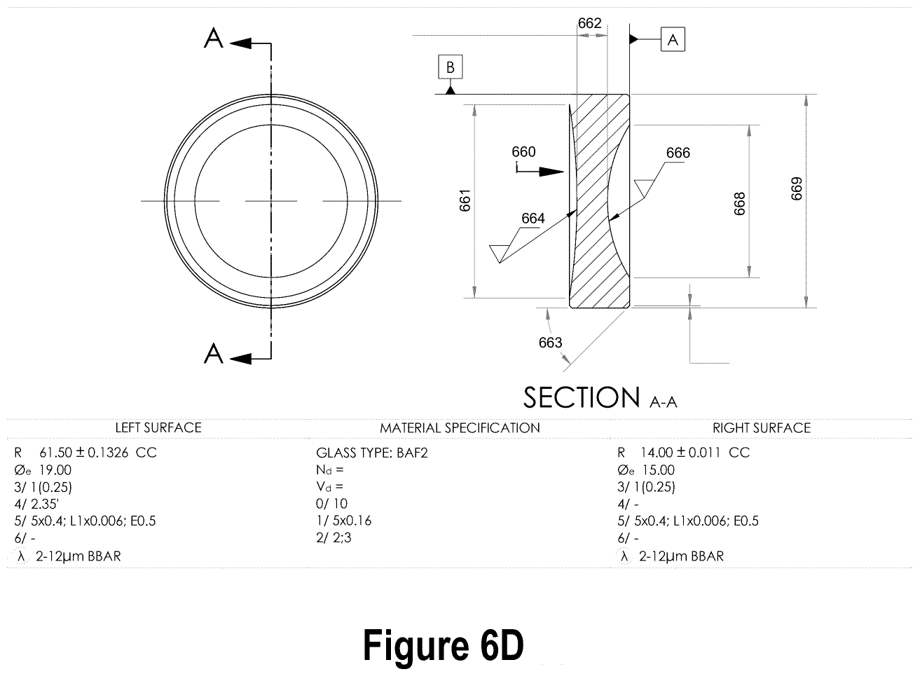

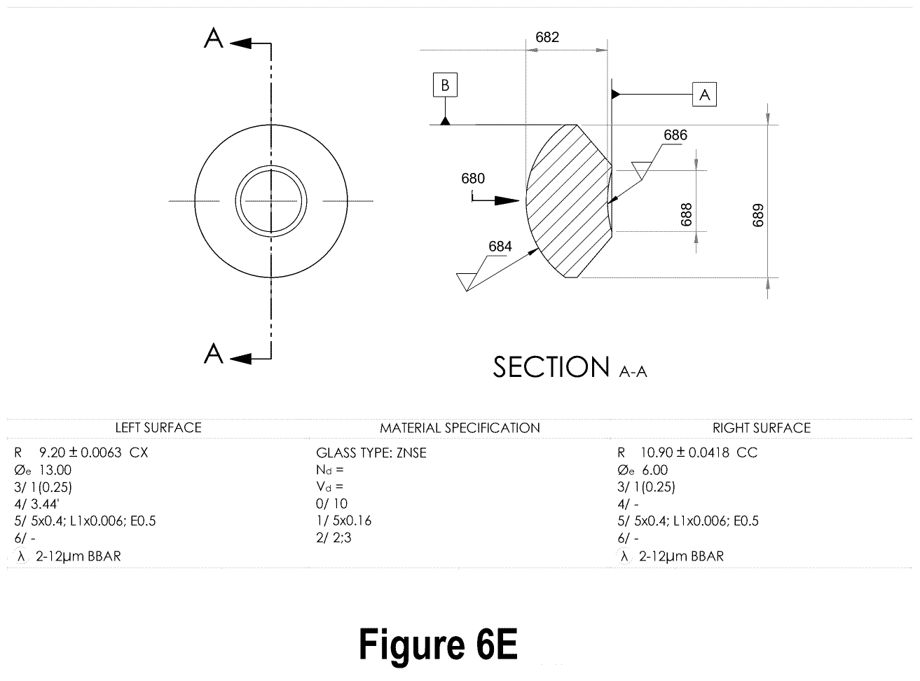

Light emitted by light emitter 110 and/or reflected off sample plane 102 and/or transflected off sample plane 102, and/or transmitted sample plane 102 may interact with various optical elements, such as scan lens 300, tube lens 400, mirror 140, and/or objective lens 600. Example embodiments of scan lens 300 will be discussed in detail in FIGS. 3A, 3B, and 3C. Likewise, example embodiments of tube lens 400 will be discussed in detail in FIGS. 4A, 4B, and 4C, and example embodiments of objective lenses, such as objective lens 600 will be discussed in detail in FIGS. 5A-5D and 6A-6E. Mirror 140 may serve to redirect light, for example from one optical axis to another.

At sample plane 102, light emitted by light emitter 110 may be configured to illuminate a portion of sample plane 102. A sample may be placed at sample plane 102. For instance, a diffraction limited spot could be illuminated on a sample at sample plane 102 within a field of view. The sample could be prepared on traditional microscopy slides. In some examples, samples may be sagittally sectioned, and prepared to be a certain thickness (e.g., 5 micrometers). The sample may be placed on standard glass or infrared reflective low-emissivity glass microscopy slides, though other possibilities exist. For example, some embodiments may use substrates that are transparent in the infrared regime with a detector located on the other side of the sample. In such cases, the light may be configured to pass through the lens system once.

Microscope 100 can include detection arm 142, which may be configured to detect light returned from sample plane 102, or from other light sources. The light may include information indicate of the illuminated portion of sample plane 102. In some example embodiments, detection arm 142 may include a pinhole 150 (e.g., with a 100 micrometer diameter). Pinhole 150 can be placed conjugate to an illumination focal spot in sample plane 102 and sized to its first minima, post-magnification, at a design wavenumber, among other possibilities. In some embodiments, the performance of pinhole 150 may not be optimal over the entire tunable spectrum. Microscope 100 may be configured to use pinhole 150 to reject out-of-focus light.

Microscope 100 can include parabolic mirror system 160, which may be configured to receive light from detection arm 142, among other possibilities. In some examples, filtered light originated from light emitter 110 and reflected off sample plane 102 may be focused using parabolic mirror system 160. For instance, parabolic mirror system 160 may be a 50 mm reflected focal length off-axis parabolic mirror (OAPM). Microscope 100 may be configured to provide focused light onto a detector 170, for instance a thermoelectrically-cooled (TE-cooled) mercury cadmium telluride (MCT) detector (e.g., a PVMI-4TE-10.6, VIGO Photonics), though other possibilities exist. In some examples, a preamplifier may be adjusted to a bandwidth of 15 MHz; thus, detector 170 may be sampled with a 250 ns delay following each light pulse.

Microscope 100 may be configured to receive via detector 170, information indicative of the illuminated portion of the sample plane and generate, based on the received information, a digital image of sample plane 102. Additionally or alternatively, detector 170 may be disposed at image plane 104 and detector 170 may be configured to convert reflected and/or received light into an electrical signal.

In some embodiments of microscope 100, data acquisition, galvanometer drive signals, digital triggering, and state monitoring, may be synchronized by a data acquisition card (e.g., PCIe-6361; National Instruments) in conjunction with microscope control software (e.g., C#.NET). The software may run on a controller, such as the one described above, or on another computing platform. These operations make take place on a controller having at least one processor and a memory, wherein the memory is operable to store program instructions that are executable by the processor to carry out the operations. The controller could be a computer, for instance a laptop computer, a desktop computer, a tablet computing device, a mobile computing device, a microscope spectroscopy device, among other possibilities.

In some embodiments, the operations may include reading out buffered pixels (e.g., as detected by detector 170) and constructing image frames. The image frames may be stored in a circular frame history buffer, and a final image may be displayed or stored by the virtual frame grabber. In some examples, the final image may consist of a recent frame (Ft) acquired at time t, co-averaged with the n-most recent frames (through Ft-n) stored in the buffer, where n is user selectable or may be automatically adjusted depending on the signal-to-noise ratio (SNR) of the laser, which may vary from band to band. Other possibilities exist.

In some embodiments, real-time monitoring of the microscopy stage, laser, and other equipment may flush the buffer in the event of state change, thereby reducing inadvertent blurring of the images. The software may be configured to construct multispectral images by sequentially grabbing frames synchronized to the laser tuning to a user-determined set of wavenumbers. Microscope 100 may also be configured to acquire point spectra at various points within the field of view at a rate of up to, for example, 10 Hz by sweeping light emitter 110.

In some embodiments, a spectral background may first be measured on a blank substrate for power referencing and non-uniformity correction. In further examples, microscope 100 may acquire 1 pixel per laser shot, resulting in a default pixel rate of, for example, 1 MHz, adjustable (for e.g., up to 2 MHz) depending on the pulse-to-pulse stability of light emitter 110. For instance, if light emitter 110 includes a QCL light source, a generated 500×500 px tile image corresponding to a field of view of 1×1 mm² (10×/0.4 numerical aperture) or 0.5×0.5 mm² (20×/0.8 numerical aperture) has a frame rate of ˜4 Hz.

Microscope 100 may also be calibrated, for example, spatially calibrated using various negative chrome on glass targets (II-VI Max Levy), e.g., USAF 1951, Siemens star, grid distortion, or Ronchi gratings. Other possibilities exist.

In some embodiments, multiple frames or images may be stitched together. For example, a larger scope could be generated by blending with a ˜10% overlap, may be is adjusted at run-time depending on the total size of the mosaic. During a scan, the software may also automatically correct for sample tilt and/or focus, potentially reducing error, for instance in longer experiments.

### Example Machine Learning

In some examples, a resulting image from microscope 100 may be post-processed with machine learning. For example, a deep neural network implementing, e.g., U-Net architecture may be trained for semantic segmentation of infrared-LSM multispectral images. For instance, to perform semantic segmentation of frozen prostate tissue into three histological units: benign, cancerous, and non-epithelial tissue. To create the dataset, regions of interest (ROIs) from eight biopsies could be imaged using an objective lenses. Different religions and/or spectral bands could be chosen, in part for suitable spatial resolution, and contrast. Additionally, different bands may help demonstrate real-world applicability, where applications may be constrained by a reduced spectral range such that some bands are accessible by potentially just a single tunable laser module, thereby reducing total system costs and improving the feasibility of clinical translation.

During training of a machine learning model, infrared-LSM images could be labeled by identifying the histologic classes in brightfield images of stained tissue, for example, in consultation with pathologists. In some examples, annotations could be copied onto the infrared-LSM data, serving as training labels. The machine learning model could be trained on 128×128 px patches, created from 368 patches of 256×256 px extracted from annotated regions and down-sampled by factor of 2. For validation, sub-regions could be removed from the training set.

In some implementations, the machine learning model architecture could contain convolution layer kernel sizes of 3×3 px. Additionally or alternatively a final could use a 1×1 px kernel to produce class probability maps. In some examples, batch-normalization can be implemented after convolutional operations to accelerate training. In some examples a softmax function could be combined with cross-entropy loss to guide optimization. In further examples, the machine leaning model could be trained for various iterations, e.g., 10,000 iterations, using the Adam optimizer with a learning rate of 10-4. Some implementations could be done PyTorch 1.3, CUDA 10.1, and/or Python 3.7.1. Different configurations, parameters, and hyperparameters could be used for the machine learning model.

### Example Lens Systems

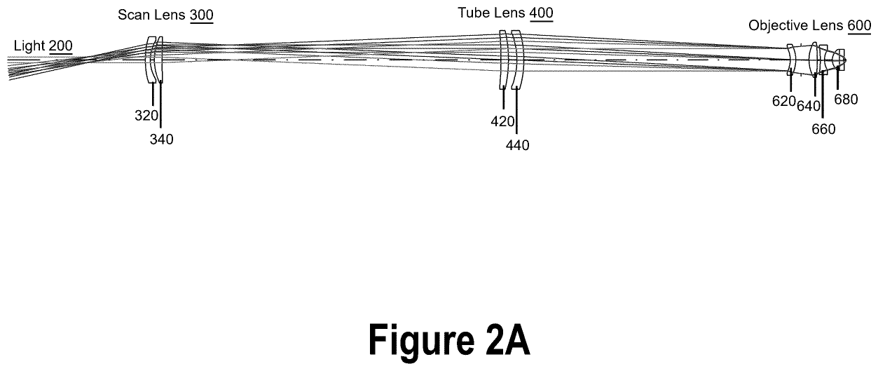

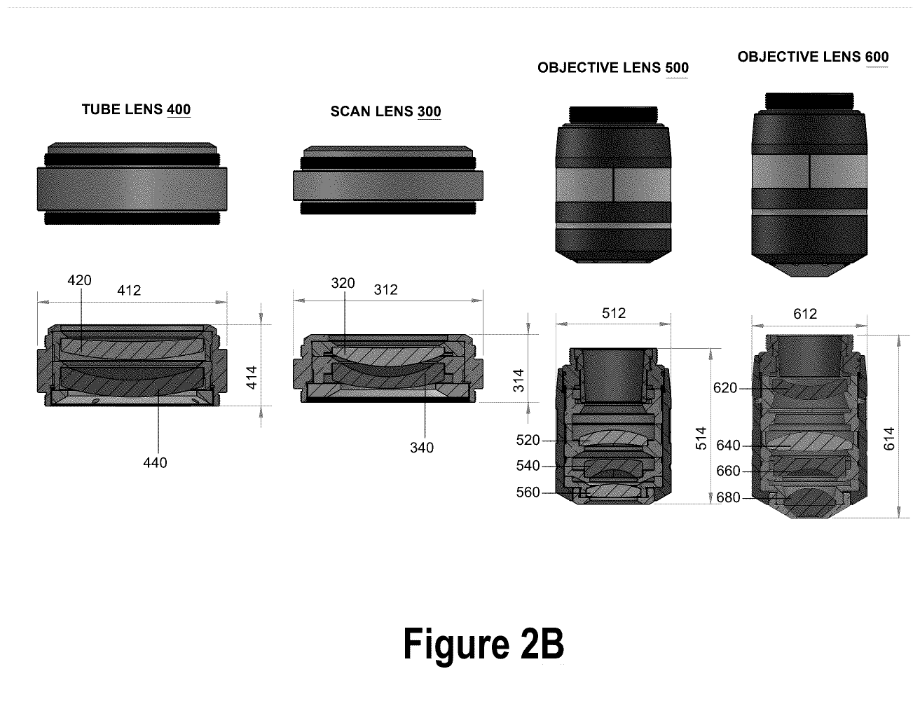

FIG. 2A illustrates an example lens system that could be used by microscope 100, or in another microscope system, to perform mid-infrared microscopy. FIG. 2A includes light 200, which may be emitted from, e.g., light emitter 110. Light 200 may pass through scan lens 300, which may include lens element 320 and/or lens element 340. Light 200 may pass through tube lens 400, which may include lens element 420 and/or lens element 440. Light 200 may pass through objective lens 600, which may include lens element 620, lens element 640, lens element 660, and/or lens element 680. Each of these lenses will be discussed in the context of FIGS. 3A-C, 4A-C, and 6A-E, respectively. Additionally or alternative, objective lens 500 of FIGS. 5A-5E could be used in place of objective lens 600. It will be understood that different lens configurations are possible and within the scope of the disclosure. Additionally, the Figures discussed below include specific embodiments (e.g., coefficients), but it will be understood that additional or alternative lens elements, spacing between lens elements, surfaces of lens elements, and/or materials may be used and are within the scope of the disclosure. For instance, each of the coefficients could be increased or decreased by 20%.

The spacing between scan lens 300 and tube lens 400, and the spacing between tube lens 400 and objective lens 600 may be based on the refractive index and/or focal length of each lens. The lenses may be configured to be along an optical axis, or as shown in FIG. 1, at least two of the lenses (e.g., scan lens 300 and tube lens 400) may be arranged along an optical axis. Other configurations of the lenses are possible and contemplated.

FIG. 2B illustrates tube lens 400, scan lens 300, objective lens 500, and objective lens 600 in more detail. Each lens may have a corresponding diameter and height. For example, tube lens 400 may have a diameter 412 and height 414. Scan lens 300 may have a diameter 312 and a height 314. Objective lens 500 may have a diameter 512 and a height 514. Objective lens 600 may have a diameter 612 and a height 614.

In some embodiments, one or more of the lenses may be designed to be apochromatic for a spectral range, and/or corrected at a number of frequency (e.g., 3 frequencies) within the range. Additionally or alternatively, one or more of the lenses may be infinity-corrected and/or telecentric. Some embodiments may use air-gapped designs, and/or may be configured to mitigate internal reflections across the design spectral range. The lenses may be designed or evaluated in simulations, e.g., Code V. The lenses may be also designed to correct for aberrations and/or using materials with higher dispersions.

Different materials may be used for the lenses, such as Germanium (Ge), Barium Fluoride (BaF₂), Zinc Selenide (ZnSe), and/or Zinc Sulfide (ZnS). Other materials, such as different plastic, glass (e.g., chalcogenide glass), silicon, fluorite, calcium fluoride, sapphire, and/or proprietary materials such as CLRTRAN, could be used in the lenses or lens elements, among other possibilities. In some cases, ZnS Cleartran™ can also be referred to as multispectral ZnS and/or MS-ZnS.

In some embodiments, the lenses may be coated, for example with an anti-reflective coating, a scratch resistance coating, among other possibilities. These coatings may be configured to improve the optical properties, the durability, or the resistance to aberrations of the lenses.

FIG. 3A illustrates scan lens 300, which may include lens element 320 and/or lens element 340. The lens elements may be aligned along an optical axis so as to refract light through them. Scan lens 300 may be configured to transmit incident light 302 along an optical axis, and may refract light 302 so as to provide light 308. Scan lens 300 may be part of a microscope (e.g., microscope 100) configured to scan light 308 (e.g., mid-infrared light) across a sample plane, for example, as part of microscope 100.

Lens element 320 and lens element 340 may be separated by spacing 330. Lens element 320 may include surface 324 and surface 326. Likewise, lens element 340 may include surface 344 and surface 346.

FIG. 3B illustrates a possible embodiment of lens element 320 in more detail. Surface 324 and/or surface 326 may be aspheric, spherical, concave, convex, plano, conic, toroidal, and/or freeform. Other possibilities exist. Lens element 320 may have a width 322, an inner height 328, an outer height 329, and an angle 323. For instance, lens element 320 may have a thickness of 8 mm. In some embodiments, lens element 320 may include BaF₂.

FIG. 3C illustrates a possible embodiment of lens element 340 in more detail. Surface 344 and/or surface 346 may be aspheric, spherical, concave, convex, plano, conic, toroidal, and/or freeform. Other possibilities exist. Lens element 340 may have a width 342, an inner height 348, an outer height 349, and an angle 343. For instance, lens element 340 may have a thickness of 4 mm. In some embodiments, lens element 340 may include ZnS.

FIG. 4A illustrates tube lens 400, which may include lens element 420 and/or lens element 440. The lens elements may be aligned along an optical axis so as to refract light through them. Tube lens 400 may be configured to transmit incident light 402 along an optical axis, and may refract light 402 so as to provide light 408. Tube lens 400 may be part of a microscope (e.g., microscope 100) configured to direct light 408 (e.g., to a refractive objective lens). Tube lens 400 may also be configured to focus the received mid-infrared light at an intermediate image plane.

Lens element 420 and lens element 440 may be separated by spacing 430. Lens element 420 may include surface 424 and surface 426. Likewise, lens element 440 may include surface 444 and surface 446.

FIG. 4B illustrates a possible embodiment of lens element 420 in more detail. Surface 424 and/or surface 426 may be aspheric, spherical, concave, convex, plano, conic, toroidal, and/or freeform. Other possibilities exist. Lens element 420 may have a width 422, an inner height 428, an outer height 429, and an angle 423. In some embodiments, lens element 420 may include BaF₂.

FIG. 4C illustrates a possible embodiment of lens element 440 in more detail. Surface 444 and/or surface 446 may be aspheric, spherical, concave, convex, plano, conic, toroidal, and/or freeform. Other possibilities exist. Lens element 440 may have a width 442, an inner height 448, an outer height 449, and an angle 443. In some embodiments, lens element 440 may include ZnS.

FIG. 5A illustrates objective lens 500, which may include lens element 520, lens element 540, and/or lens element 560. The lens elements may be aligned along an optical axis so as to refract light through them. Objective lens 500 may be configured to transmit incident light 502 along an optical axis, and may refract light 502 so as to provide light 508. Objective lens 500 may be part of a microscope (e.g., microscope 100) configured to focus light 508 (e.g., mid-infrared light) onto a sample plane, for example sample plane 102 of microscope 100. In some embodiments, the numerical aperture of objective lens 500 may be 0.4. Other numerical apertures are possible and contemplated.

Lens element 520 and lens element 540 may be separated by spacing 530, and lens element 540 and lens element 560 may be separated by spacing 550. Lens element 520 may include surface 524 and surface 526. Likewise, lens element 540 may include surface 544 and surface 546, and lens element 560 may include surface 564 and surface 566.

FIG. 5B illustrates a possible embodiment of lens element 520 in more detail. Surface 524 and/or surface 526 may be aspheric, spherical, concave, convex, plano, conic, toroidal, and/or freeform. Other possibilities exist. Lens element 520 may have a width 522, an inner height 528, an outer height 529, and an angle 523. In some embodiments, lens element 520 may include ZnS.

FIG. 5C illustrates a possible embodiment of lens element 540 in more detail. Surface 544 and/or surface 546 may be aspheric, spherical, concave, convex, plano, conic, toroidal, and/or freeform. Other possibilities exist. Lens element 540 may have a width 542, an inner height 528, an outer height 549, and an angle 543. In some embodiments, lens element 540 may include BaF₂.

FIG. 5D illustrates a possible embodiment of lens element 560 in more detail. Surface 564 and/or surface 566 may be aspheric, spherical, concave, convex, plano, conic, toroidal, and/or freeform. Other possibilities exist. Lens element 560 may have a width 562, an inner height 568, and an angle 563. In some embodiments, lens element 560 may include ZnS.

FIG. 6A illustrates objective lens 600, which may include lens element 620, lens element 640, lens element 660 and/or lens element 680. The lens elements may be aligned along an optical axis so as to refract light through them. Objective lens 600 may be configured to transmit incident light 602 along an optical axis, and may refract light 602 so as to provide light 608. Objective lens 600 may be part of a microscope (e.g., microscope 100) configured to focus light 608 (e.g., mid-infrared light) onto a sample plane, for example sample plane 102 of microscope 100. In some embodiments, the numerical aperture of objective lens 600 may be 0.8. Other numerical apertures are possible and contemplated.

Lens element 620 and lens element 640 may be separated by spacing 630, lens element 640 and lens element 660 may be separated by spacing 650, and lens element 660 and lens element 680 may be separated by spacing 670. Lens element 620 may include surface 624 and surface 626. Likewise, lens element 40 may include surface 644 and surface 646, lens element 660 may include surface 664 and surface 666, and lens element 680 may include surface 684, surface 685, and surface 686.

FIG. 6B illustrates a possible embodiment of lens element 620 in more detail. Surface 624 and/or surface 626 may be aspheric, spherical, concave, convex, plano, conic, toroidal, and/or freeform. Other possibilities exist. Lens element 620 may have a width 622, an inner height 628, an outer height 629, and an angle 623. In some embodiments, lens element 620 may include ZnSe.

FIG. 6C illustrates a possible embodiment of lens element 640 in more detail. Surface 644 and/or surface 646 may be aspheric, spherical, concave, convex, plano, conic, toroidal, and/or freeform. Other possibilities exist. Lens element 640 may have a width 642, an inner height 648, and an angle 643. In some embodiments, lens element 640 may include ZnS.

FIG. 6D illustrates a possible embodiment of lens element 660 in more detail. Surface 664 and/or surface 666 may be aspheric, spherical, concave, convex, plano, conic, toroidal, and/or freeform. Other possibilities exist. Lens element 660 may have a width 662, an inner height 668, an outer height 669, and an angle 663. In some embodiments, lens element 660 may include BaF₂.

FIG. 6E illustrates a possible embodiment of lens element 680 in more detail. Surface 684 and/or surface 686 may be aspheric, spherical, concave, convex, plano, conic, toroidal, and/or freeform. Other possibilities exist. Lens element 680 may have a width 682, an inner height 688, and an outer height 689. In some embodiments, lens element 680 may include ZnSe.

### III. EXAMPLE OPERATIONS

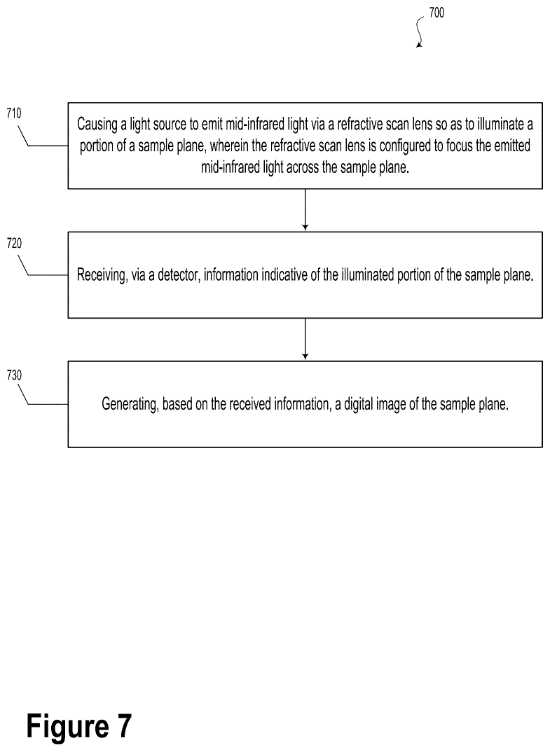

FIG. 7 illustrates an example method 700 of using refractive lenses for microscopy in the mid-infrared regime. It will be understood that method 700 may include fewer or more steps or blocks than those expressly illustrated or otherwise disclosed herein. Furthermore, respective steps or blocks of method 700 may be performed in any order and each step or block may be performed one or more times. In some embodiments, some or all of the blocks or steps of method 700 may be carried out by elements of microscope 100 and/or other microscope systems, as illustrated and described with respect to FIG. 1.

Block 710 of method 700 includes causing a light source to emit mid-infrared light via a refractive scan lens so as to illuminate a portion of a sample plane, wherein the refractive scan lens is configured to focus the emitted mid-infrared light across the sample plane. Block 720 includes receiving, via a detector, information indicative of the illuminated portion of the sample plane. Block 730 includes generating, based on the received information, a digital image of the sample plane.

Some embodiments may include a plurality of lenses for focusing emitted mid-infrared light at a sample plane and collecting received mid-infrared light at an image plane. The plurality of lenses may be configured to refractively interact with the emitted mid-infrared light and the received mid-infrared light. The plurality of lenses may include: a refractive scan lens, where the refractive scan lens may be configured to focus the emitted mid-infrared light at an intermediate image plane and where the refractive scan lens may be configured to be adjusted by a beam steering device, a refractive objective lens, where the refractive objective lens may be configured to focus the emitted mid-infrared light at the sample plane, and a refractive tube lens, where the refractive tube lens may be configured to direct the emitted mid-infrared light to the refractive objective lens and where the refractive tube lens may be configured to focus the received mid-infrared light at the intermediate image plane. At least two of the plurality of lenses may be arranged along an optical axis.

In some embodiments, the emitted mid-infrared light includes wavelengths between 2 micrometers and 12 micrometers.

In some embodiments, the refractive scan lens includes a first scan lens element, wherein the first scan lens element includes an aspheric surface and a second scan lens element, wherein the second scan lens element includes an aspheric surface. In some further embodiments, the first scan lens element includes barium fluoride (BaF₂) and the second scan lens element includes zinc sulfide (ZnS).

In some embodiments, the refractive tube lens includes a first tube lens element, wherein the first tube lens element includes an aspheric surface and a second tube lens element, wherein the second tube lens element includes an aspheric surface. In some further embodiments, the first tube lens element includes barium fluoride (BaF₂) and the second tube lens element includes zinc sulfide (ZnS).

In some embodiments, the refractive objective lens is infinity-corrected.

In some embodiments, the refractive objective lens includes a first objective lens element, wherein the first objective lens element includes an aspheric surface and includes zinc sulfide (ZnS), a second objective lens element, wherein the second objective lens element includes an aspheric surface and includes barium fluoride (BaF₂) and a third objective lens element, wherein the third objective lens element includes zinc sulfide (ZnS). In some further embodiments, the refractive objective lens has a magnification of 10 and a numerical aperture of 0.3-0.5.

In some embodiments, the refractive objective lens includes a first objective lens element, wherein the first objective lens element includes an aspheric surface and includes zinc selenide (ZnSe), a second objective lens element, wherein the second objective lens element includes an aspheric surface and includes zinc sulfide (ZnS), a third objective lens element, wherein the third objective lens element includes barium fluoride (BaF₂), and a fourth objective lens element, wherein the fourth objective lens element includes zinc selenide (ZnSe). In some further embodiments, the refractive objective lens has a magnification of 20 and a numerical aperture of 0.7-0.9.

In some embodiments, the light source includes an external cavity (EC) quantum cascade laser (QCL) array. In some further embodiments, the light source may be configured to emit the emitted mid-infrared light along the optical axis toward the sample plane. Some embodiments may include a detector, where the detector may be disposed at the image plane, and may be configured to convert the received mid-infrared light into an electrical signal.

### IV. CONCLUSION

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A system comprising:
a plurality of lenses for focusing emitted mid-infrared light at a sample plane and collecting received mid-infrared light at an image plane, wherein the plurality of lenses are configured to refractively interact with the emitted mid-infrared light and the received mid-infrared light, the plurality of lenses comprising:
a refractive scan lens, wherein the refractive scan lens is configured to focus the emitted mid-infrared light at an intermediate image plane and wherein the refractive scan lens is configured to be adjusted by a beam steering device;
a refractive objective lens, wherein the refractive objective lens is configured to focus the emitted mid-infrared light at the sample plane; and
a refractive tube lens, wherein the refractive tube lens is configured to direct the emitted mid-infrared light to the refractive objective lens and wherein the refractive tube lens is configured to focus the received mid-infrared light at the intermediate image plane, wherein at least two of the plurality of lenses are arranged along an optical axis.

2. The system of claim 1, wherein the emitted mid-infrared light comprises wavelengths between 2 micrometers and 12 micrometers.

3. The system of claim 1, wherein the refractive scan lens comprises:
a first scan lens element, wherein the first scan lens element comprises an aspheric surface; and
a second scan lens element, wherein the second scan lens element comprises an aspheric surface.

4. The system of claim 3, wherein the first scan lens element comprises barium fluoride (BaF₂) and the second scan lens element comprises zinc sulfide (ZnS).

5. The system of claim 1, wherein the refractive tube lens comprises:
a first tube lens element, wherein the first tube lens element comprises an aspheric surface; and
a second tube lens element, wherein the second tube lens element comprises an aspheric surface.

6. The system of claim 5, wherein the first tube lens element comprises barium fluoride (BaF₂) and the second tube lens element comprises zinc sulfide (ZnS).

7. The system of claim 1, wherein the refractive objective lens is infinity-corrected.

8. The system of claim 1, wherein the refractive objective lens comprises:
a first objective lens element, wherein the first objective lens element comprises an aspheric surface and comprises zinc sulfide (ZnS);
a second objective lens element, wherein the second objective lens element comprises an aspheric surface and comprises barium fluoride (BaF₂); and
a third objective lens element, wherein the third objective lens element comprises zinc sulfide (ZnS).

9. The system of claim 8, wherein the refractive objective lens has a magnification of 10 and a numerical aperture of 0.3-0.5.

10. The system of claim 1, wherein the refractive objective lens comprises:
a first objective lens element, wherein the first objective lens element comprises an aspheric surface and comprises zinc selenide (ZnSe);
a second objective lens element, wherein the second objective lens element comprises an aspheric surface and comprises zinc sulfide (ZnS);
a third objective lens element, wherein the third objective lens element comprises barium fluoride (BaF₂); and
a fourth objective lens element, wherein the fourth objective lens element comprises zinc selenide (ZnSe).

11. The system of claim 10, wherein the refractive objective lens has a magnification of 20 and a numerical aperture of 0.7-0.9.

12. The system of claim 1, further comprising:
a light source, wherein the light source is configured to emit the emitted mid-infrared light along the optical axis toward the sample plane; and
a detector, wherein the detector is disposed at the image plane, and configured to convert the received mid-infrared light into an electrical signal.

13. The system of claim 12, wherein the light source comprises an external cavity (EC) quantum cascade laser (QCL) array.

14. The system of claim 12, further comprising:
a controller having at least one processor and a memory, wherein the memory is operable to store program instructions that are executable by the at least one processor to carry out operations, the operations comprising:
causing the light source to emit the emitted mid-infrared light toward the sample plane;
receiving, via the detector, information indicative of an illuminated portion of the sample plane; and
generating, based on the received information, a digital image of the sample plane.

15. A system comprising:
a plurality of lenses for focusing emitted mid-infrared light at a sample plane and collecting received mid-infrared light at an image plane, wherein the plurality of lenses are configured to refractively interact with the emitted mid-infrared light and the received mid-infrared light, the plurality of lenses comprising:
a refractive scan lens, wherein the refractive scan lens is configured to focus the emitted mid-infrared light across the sample plane and wherein the refractive scan lens is configured to be adjusted by a beam steering device,
wherein the plurality of lenses are arranged along an optical axis.

16. The system of claim 15, wherein the emitted mid-infrared light comprises wavelengths between 2 micrometers and 12 micrometers.

17. The system of claim 15, wherein the refractive scan lens comprises:
a first scan lens element, wherein the first scan lens element comprises an aspheric surface; and
a second scan lens element, wherein the second scan lens element comprises an aspheric surface.

18. A method for laser scanning microscopy comprising:
causing a light source to emit mid-infrared light via a refractive scan lens so as to illuminate a portion of a sample plane, wherein the refractive scan lens is configured to focus the emitted mid-infrared light across the sample plane;
receiving, via a detector, information indicative of the illuminated portion of the sample plane; and
generating, based on the received information, a digital image of the sample plane.

19. The method of claim 18, wherein the mid-infrared light comprises wavelengths between 2 micrometers and 12 micrometers.

20. The method of claim 18, wherein the light source is configured to emit the mid-infrared light through a confocal pinhole so as to reject out-of-focus mid-infrared light.
